(19) United States
(12) Patent Application Publication
(10) Pub. No.: US 2010/0034934 A1
(43) Pub. Date: Feb. 11, 2010

(54) PACKAGING FOR STABILIZING CONSUMABLE PRODUCTS

(75) Inventor: Shi-Qiu ZHANG, Englewood Cliffs, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/187,614

(22) Filed: Aug. 7, 2008

(51) Int. Cl. B65D 85/00; A23F 3/00; A23F 3/16

(52) U.S. Cl. 426/127; 426/106; 426/597; 426/506

(57) ABSTRACT

Packaging for stabilizing consumable products is described. The packaging has a defined amount of oxygen in its headspace and product portion whereby products packaged in the same are stable in the absence of oxygen scavengers.

### FIELD OF THE INVENTION

The present invention is directed to packaging for stabilizing consumable products. More particularly, the invention is directed to packaging for stabilizing consumable beverage products, especially precursors for making the same. The packaging of the present invention, surprisingly, is suitable to stabilize aqueous-based consumable products without requiring the use of oxygen scavenging agents in the product and/or the packaging.

### BACKGROUND OF THE INVENTON

Excluding water, tea is the most popular beverage consumed by man. Tea is very refreshing, can be served either hot or cold and has been made commercially available for many years. Lipton®, for example, is the world's leading brand of tea, made commercially available in over 110 countries by Unilever.

Traditional consumable products, including food composition precursors (e.g., tea concentrates), can be difficult to stabilize. Notwithstanding this, many food service establishments require precursors for making products whereby such precursors are further required to have long shelf lives. In order to achieve the requirements set, for example, by food service establishments, preservatives and/or radical scavengers are often used, either in the product, package or both. Other alternatives include the use of precursor powders which have significantly less water than liquid products and can be more stable than products of high water content. The use of radical scavengers and preservatives are not always desirable since many consumers tend to want natural products free of preservatives and synthetic additives (which radical scavengers tend to be). Liquid concentrates, for example, are often desired because they give the consumer an impression of freshness, are convenient for dissolving in water and yield good tasting beverages upon dilution. Such concentrates, however, are difficult to stabilize, especially naturally.

There is an increasing interest to develop packaging suitable to stabilize consumable products and precursors for making the same in the absence of oxygen scavengers. This invention, therefore, is directed to superior packaging for stabilizing consumable products as well as precursors for making the same. The packaging is, surprisingly, suitable to stabilize products (especially liquid products) without requiring the use of oxygen scavenging agents. Moreover, the packaging can be used to stabilize precursors, like tea concentrate, for at least about twenty-two (22) weeks at ambient temperature.

### Additional Information

Efforts have been disclosed for preserving foods. In Japanese Publication No. 11-028779, methods for preserving liquid tea or paste tea are described.

Other efforts have been described for preserving foods. In WO 2004/103081 A2, methods for extending the shelf life of ready cut meats are described.

Still other efforts have been described for preserving foods. In U.S. Pat. Nos. 5,773,062 and 5,738,888, methods for stabilizing tea beverages are described.

None of the additional information above describes packaging for stabilizing consumable products where the packaging has a headspace with a defined initial oxygen content, a product with a defined initial oxygen content and an atmospheric oxygen permeation rate as described in this invention.

### SUMMARY OF THE INVENTION

In a first aspect, the present invention is directed to a packaged product comprising:
a) a sealed flexible package;
b) a product portion comprising product within the package; and
c) a headspace above the product portion
   wherein the headspace has an initial oxygen content (Hₒᵢ) from about 0 to about 0.05 cm³ and the product has an initial oxygen content (Pₒᵢ) from about 0.05 to about 0.4 cm³ further wherein oxygen from the atmosphere permeates into the headspace at a headspace permeation rate (f) and into the product portion at a product portion permeation rate (F) where f/F does not exceed 0.03, the product in the package being shelf stable for at least about twenty-two (22) weeks (preferably, at least about twenty-two (22) weeks to twenty-six (26) weeks) at ambient temperature.

In a second aspect, the present invention is directed to a consumable product made with the packaged product of the first aspect of the invention.

In a third aspect, the present invention is directed to a method for making the consumable product of the second aspect of this invention.

All other aspects of the present invention will more readily become apparent upon considering the detailed description and examples which follow.

Consumable product, as used herein, is defined to mean a composition or product ready for consumption by humans. Precursor, as used herein, is meant to mean a product that may be used to prepare a consumable product. Precursor, therefore, is meant to include a product that can be mixed with other foods as well as a product that may be diluted with a diluent, like water. A precursor within the scope of this invention is a tea concentrate suitable to be diluted with water to yield a ready-to-drink tea beverage. Headspace, as used herein, means the internal space in the package and above the product. Product portion, as used herein, means the internal space within the package that has product and is below the headspace. Package means like a pouch. Flexible is defined to mean capable of being bent, and preferably, heat sealable. Headspace permeation rate (f) means the permeation rate of oxygen from the atmosphere into the headspace and product portion permeation rate (F) means the permeation rate of oxygen from the atmosphere into the product portion, taken as an initial permeation rate and within ten (10) minutes of packaged product manufacturing. When a consumable product is packaged or produced from a packaged precursor, stable, as used herein, means having excellent taste characteristics and free of visible precipitate. In the case of precursors such as tea concentrates used to produce a ready-to-drink tea beverage, stable is meant to mean for at least about twenty-two (22) weeks (preferably, from about 22-26 weeks) at room temperature, the precursor is suitable for dilution to result in a tea beverage that tastes similar to fresh brewed tea and has a Hunter Haze Value of less than about 68, and L (darkness) and a (redness) values of greater than about 19, and preferably from about 19 to about 23 as measured on a Hunter DP 9000 Spectrophotometer in a 5 cm cell. Comprising, as used herein, is meant to include consisting essentially of and consisting of. All ranges identified herein are meant to implicitly include all ranges subsumed therein, if, for example, reference to the same is not explicitly made.

### DETAILED DESCRIPTION OF THE PREFERRED EMBODIMENTS

The only limitation with respect to the flexible material used to make the packaged product of the present invention is that the material employed is suitable for use with consumable products and able to yield a headspace permeation rate (f) and a product portion permeation rate (F) whereby f/F does not exceed 0.03, and preferably, is between from about 0.01 to about 0.02. Illustrative and non-limiting examples of the type of flexible material suitable for use in this invention include those comprising polypropylene, nylon, ethylvinyl alcohol, polyethylene, polyethylene terephthalate, polycarbonate and polyvinylchloride, as well as blends and co-polymers thereof. The flexible material suitable for use may also be a combination of polymeric films, including a combination of polymeric films that have as a film layer (and preferably a middle film layer) a metal foil such as one comprising aluminum. Such materials may be purchased from suppliers like United States Plastic Corp., Valeron Strength Films, Plastic Film Corporation and Curwood, Inc. In a preferred embodiment, the material comprises polypropylene metal foil and polyethylene terephthalate. In yet another preferred embodiment, the flexible material and product are substantially free of radical scavengers (i.e., less than 0.2% by weight based on total weight of the flexible material and less than 0.2% by weight based on total weight of the product), and preferably, free of radical scavengers. When preparing or assembling the packaged product of the present invention, the flexible material may be heat sealed and/or sealed with food grade adhesives like retortable adhesives. A product filling device which may be used includes one having a gas dispersing hood extended over a portion of a turret. The hood dispenses gas continuously to form a gas curtain which covers the top of the pouch. While under the hood, the pouch is purged at an upstream purging station with a diving nozzle and moved to a filling station where a fill tube dispenses product. The package may be moved to a downstream purging station when the top of the pouch over the filled product can be purged before sealing. A more detailed description of processes for making flexible packages may be found in U.S. Pat. Nos. 4,027,450 and 6,199,601, the disclosures of which are incorporated herein by reference.

Typically, the headspace has a volume which makes up from about 0.5 to about 10%, and preferably, from about 0.6 to about 7% and most preferably, from about 0.8 to about 3% the volume of the sealed, flexible package, based on total volume of the sealed, flexible package and including all ranges subsumed therein.

In an often preferred embodiment, Hₒᵢ is from about 0.001 to about 0.03 cm³, and most preferably, from about 0.001 to about 0.01 cm³, and Pₒᵢ is preferably from about 0.06 to about 0.3 cm³, and most preferably, from about 0.04 to 0.2 cm³, including all ranges subsumed therein. Inert gas purging techniques, such as purging with nitrogen, may be used in order to achieve the desired initial oxygen contents of this invention, in both the headspace and product.

In yet another often preferred embodiment, f is from about 0.5×10⁻⁴ to about 1.7×10⁻⁴ cm³/day, and most preferably, from about 1.0×10⁻⁴ to about 1.3×10⁻⁴ cm³/day, and F is preferably from about 5×10⁻³ to about 7.5×10⁻³ cm³/day, and preferably, from about 6.4×10⁻³ to about 7×10⁻³ cm³/day, including all ranges subsumed therein.

Illustrative consumable products which may be packaged in the product portion of the present invention include, for example, a beverage, spread, sauce, dip, spoonable dressing, pourable dressing, dairy-based product, pasta composition, meal supplement or replacement drink or a meal supplement or replacement bar. In a preferred embodiment, however, the product portion comprises a product precursor (i.e., tea concentrate) for making ready-to-drink tea like ready-to-drink green, black, oolong, white or herbal tea.

A ready-to-drink tea precursor suitable to be packaged in the product portion of the package of this invention means a product derived from concentrated tea extract which is diluted with water to form a drinkable tea beverage, Tea precursors suitable for use herein comprise, for example, from about 5% to about 80% tea solids. Preferred tea precursors comprise from about 12% to about 30% by weight tea solids. The tea precursors are preferably in liquid product form. The dilution water is usually municipal water, but deionized water can be used to advantage. Precursors for use in the present invention are generally diluted with sufficient water to provide the tea beverage. Preferred tea precursors are typically diluted to about 0.1% to 0.35% tea solids to provide the tea beverages.

Tea solids refer to those solids normally presented in a tea extract. Polyphenolic compounds are normally the primary component of tea solids. However, tea solids can also include caffeine, proteins, amino acids, minerals and carbohydrates.

Illustrative precursors suitable for use in this invention include those described in U.S. Pat. No. 6,413,570, the disclosure of which is incorporated herein by reference.

It is within the scope of this invention to employ optional food precursor additives like a chelator, colorant, preservative (e.g., potassium sorbate, sodium benzoate), flavor, vitamin, sweetener, fruit juices, surfactant (like sorbitan monolaurate and sorbitan monopalmitate), acidulant and the like. When employed, such optional additives, collectively, make up less than about 15.0% by weight of the total weight of the food precursor.

An example of the type of dispenser suitable for use in this invention is one which combines precursor with a liquid, like water and in order to produce a ready-to-drink beverage, like a tea beverage. Such a dispenser typically combines about 2.0 parts of precursor and about 95 to about 100 parts by weight liquid in order to produce the desired consumable composition (typically dispensed at 500 milliliters). A more detailed description of the type of dispenser suitable for use in this invention is described for example, in U.S. Pat. Nos. 6,792,847 and 6,685,059, and U.S. Patent Application No. 2003/0116025, the disclosures of which are incorporated herein by reference. Other options include mixing the precursor and water by stirring with a hand-held mixing device like a spoon in an open vessel such as a mixing can. The size of the packaged product is limited only to the extent that it is suitable to be handled by a consumer. Such a packaged product can, therefore, be large enough for numerous individual servings or small enough for a single serving to, for example, be emptied into a bottled water product.

The following examples are provided to facilitate an understanding of the invention. The examples are not intended to limit the scope of the claims.

### EXAMPLE 1

Tea concentrate made available by Unilever under the Lipton® Tea Brand was packaged in flexible packaging and stored in the manner described below. The concentrate was circa 15% by weight tea solids. After storage, 6.7 grams of concentrate were combined with 500 mL of water (hardness about 110) to yield a ready-to-drink tea which was assessed for appearance, taste, as well as Hunter Haze, L (darkness) and a (redness) values. The packages, after sealing, were approximately 20_{cm}×12_{cm} and had a headspace volume at about 3.2% of the total volume of the package. Packages identified as 1 contained ethylvinyl alcohol and linear, low density polyethylene, those identified as 2 contained polypropylene and aluminum oxide composite, those identified as 3 and 5 contained polyethylene and oxygen scavenger, and those identified as 4 contained polypropylene and an aluminum foil. Stable samples (as defined herein), had a headspace permeation rate (f) of about, 0.8×10⁻⁴ cm³/day and a product permeation rate (F) of about 6×10⁻³ cm³/day.

Packages denoted as (a) had 100% nitrogen in the headspace, and the packages denoted as (b) contained 20% oxygen (i.e., air) in the headspace. The packages defined with a (c) contained 100% oxygen in the headspace.

The results at 4° C. demonstrate the effect of oxygen levels on tea concentrate after two (2) weeks. The results at eighteen (18) weeks demonstrate that the oxygen level in the headspace effects product quality. At twenty-two (22) weeks the data demonstrates that under conditions consistent with those of the present invention, stability can equal the stability of a two (2) week old sample stored at 4° C. (see Samples 4a at 22 weeks and 1b at 2 weeks). At twenty-six (26) weeks, it is shown that when conditions are consistent with those of the present invention, tea concentrate stability is obtained, even at ambient temperature (Sample 4a).

| Flexible | Time of | | | | |
|---|---|---|---|---|---|
| Packaging | Evaluation | Temperature | L | a | Haze |
| 1a | 2 weeks | 4° C. | 32 | 29 | 28 |
| 1b | 2 weeks | 4° C. | 25 | 25 | 69 |
| 1c | 2 weeks | 4° C. | 29 | 28 | 68 |
| 2a | 2 weeks | 4° C. | 32 | 29 | 31 |
| 2b | 2 weeks | 4° C. | 30 | 28 | 57 |
| 2c | 2 weeks | 4° C. | 25 | 25 | 63 |
| 3a | 2 weeks | 4° C. | 32 | 29 | 27 |
| 3b | 2 weeks | 4° C. | 26 | 25 | 61 |
| 3c | 2 weeks | 4° C. | 25 | 25 | 70 |
| 4a | 2 weeks | 4° C. | 32 | 29 | 26 |
| 4b | 2 weeks | 4° C. | 26 | 26 | 57 |
| 4c | 2 weeks | 4° C. | 30 | 28 | 58 |
| 5a | 2 weeks | 4° C. | 32 | 29 | 28 |
| 5b | 2 weeks | 4° C. | 26 | 26 | 57 |
| 5c | 2 weeks | 4° C. | 30 | 28 | 58 |
| 1a | 18 weeks | ambient | 23 | 22 | 60 |
| 1b | 18 weeks | ambient | 17 | 18 | 89 |
| 1c | 18 weeks | ambient | 18 | 19 | 84 |
| 2a | 18 weeks | ambient | 23 | 21 | 65 |
| 2b | 18 weeks | ambient | 18 | 18 | 87 |
| 2c | 18 weeks | Ambient | 21 | 20 | 81 |
| 3a | 18 weeks | ambient | 23 | 22 | 60 |
| 3b | 18 weeks | ambient | 18 | 19 | 84 |
| 3c | 18 weeks | ambient | 21 | 20 | 84 |
| 4a | 18 weeks | ambient | 23 | 22 | 58 |
| 4b | 18 weeks | ambient | 18 | 19 | 87 |
| 4c | 18 weeks | ambient | 21 | 20 | 85 |
| 5a | 18 weeks | ambient | 22 | 22 | 64 |
| 5b | 18 weeks | ambient | 18 | 19 | 85 |
| 5c | 18 weeks | ambient | 17 | 18 | 88 |
| 1a | 22 weeks | ambient | 22 | 20 | 67 |
| 1b | 22 weeks | ambient | 15 | 17 | 91 |
| 1c | 22 weeks | ambient | 15 | 18 | 88 |
| 2a | 22 weeks | ambient | 21 | 20 | 77 |
| 2b | 22 weeks | ambient | 17 | 18 | 89 |
| 2c | 22 weeks | ambient | 16 | 17 | 91 |
| 3a | 22 weeks | ambient | 21 | 20 | 67 |
| 3b | 22 weeks | ambient | 17 | 18 | 85 |
| 3c | 22 weeks | ambient | 16 | 17 | 91 |
| 4a | 22 weeks | ambient | 22 | 20 | 64 |
| 4b | 22 weeks | ambient | 17 | 18 | 86 |
| 4c | 22 weeks | Ambient | 19 | 18 | 87 |
| 5a | 22 weeks | ambient | 21 | 21 | 71 |
| 5b | 22 weeks | ambient | 16 | 18 | 90 |
| 5c | 22 weeks | ambient | 16 | 18 | 89 |
| 1a | 26 weeks | ambient | 19 | 20 | 74 |
| 1b | 26 weeks | ambient | 14 | 17 | 93 |
| 1c | 26 weeks | ambient | 18 | 18 | 89 |
| 2a | 26 weeks | ambient | 21 | 19 | 76 |
| 2b | 26 weeks | ambient | 16 | 17 | 90 |
| 2c | 26 weeks | ambient | 15 | 16 | 92 |
| 3a | 26 weeks | ambient | 21 | 19 | 71 |
| 3b | 26 weeks | ambient | 16 | 17 | 89 |
| 3c | 26 weeks | ambient | 16 | 17 | 90 |
| 4a | 26 weeks | ambient | 21 | 19 | 67 |
| 4b | 26 weeks | ambient | 17 | 17 | 89 |
| 4c | 26 weeks | ambient | 19 | 18 | 87 |
| 5a | 26 weeks | ambient | 20 | 20 | 72 |
| 5b | 26 weeks | ambient | 15 | 17 | 91 |
| 5c | 26 weeks | ambient | 18 | 18 | 87 |

### EXAMPLE 2

Skilled panelists sampled tea beverages made with twenty-two (22) week tea concentrate packaged according to this invention. All panelists concluded that the tea beverages had excellent tastes characteristics and the taste consistent with fresh brewed tea.

What is claimed is:

1. A packaged product comprising:
(a) a sealed flexible package;
(b) a product portion comprising product within the package; and
(c) a headspace above the product portion
wherein the headspace has an initial oxygen content (Hₒᵢ) from about 0 to about 0.05 cm³ and the product has an initial oxygen content (Pₒᵢ) from about 0.05 to about 0.4 cm³, further wherein oxygen from the atmosphere permeates into the headspace at a headspace permeation rate (f) and into the product portion at a product portion permeation rate (F) where f/F does not exceed 0.03, the product in the package being shelf stable for at least about twenty-two (22) weeks at ambient temperature.

2. The packaged product according to claim 1 wherein the sealed flexible package comprises polypropylene, polyethylene, nylon, ethylvinyl alcohol, polyethylene terephthalate, polycarbonate, polyvinylchloride or a blend or copolymer thereof.

3. The packaged product according to claim 2 wherein the sealed flexible package comprises a combination of polymer films and further comprises a metal foil.

4. The packaged product according to claim 1 wherein f/F is from about 0.01 to about 0.02.

5. The packaged product according to claim 1 wherein Hₒᵢ is from about 0.001 to about 0.03 cm³.

6. The packaged product according to claim 1 wherein Hₒᵢ is from about 0.001 to about 0.01 cm³.

7. The packaged product according to claim 1 wherein Pₒᵢ is from about 0.06 to about 0.25 cm³.

8. The packaged product according to claim 1 wherein Pₒᵢ is from about 0.04 cm³/mL product to about 0.2 cm³.

9. The packaged product according to claim 1 wherein the headspace makes up from about 0.5 to about 10% of flexible package volume.

10. The packaged product according to claim 1 wherein the product is a beverage or a beverage precursor.

11. The packaged product according to claim 1 wherein the product is a beverage precursor.

12. The packaged product according to claim 11 wherein the beverage precursor is a ready-to-drink tea precursor comprising from about 5 to about 80% by weight tea solids.

13. The packaged product according to claim 1 wherein f is from about 0.5×10⁻⁴ to about 1.7×10⁻⁴ cm³/day.

14. The packaged product according to claim 1 wherein F is from about 5×10⁻³ to about 7.5×10⁻³ cm³/day.

15. The packaged product according to claim 1 wherein the product is stable for at least about 22 weeks at ambient temperature.

16. A tea beverage made by diluting the product of claim 1.

17. A method for making a beverage by diluting the product of claim 1.

18. The method of claim 17 wherein the beverage is a tea beverage and dilution is with water.
